(19) United States
(12) Patent Application Publication
(10) Pub. No.: US 2010/0262873 A1
(43) Pub. Date: Oct. 14, 2010

(54) APPARATUS AND METHOD FOR DIVIDING AND DISPLAYING IP ADDRESS

(76) Inventors: Beomhwan Chang, Daejeon (KR); Chiyoon Jeong, Daejeon (KR); Seongyoung Sohn, Daejeon (KR); Geonlyang Kim, Daejeon (KR); Jonghyun Kim, Daejeon-city (KR); Jongho Ryu, Chungnam (KR); Jungchan Na, Daejeon (KR); Jongsoo Jang, Daejeon (KR); Sungwon Sohn, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/808,890

(22) PCT Filed: Sep. 3, 2008
(86) PCT No.: PCT/KR08/05175

§ 371 Date: Jun. 17, 2010

(30) Foreign Application Priority Data
Dec. 18, 2007 (KR) 10-2007-0133083

(51) Int. Cl. G06F 11/32

(52) U.S. Cl. 714/57; 714/E11.18

(57) ABSTRACT

Disclosed is an apparatus and method of dividing and displaying an IP address that displays a combination of important attributes of security events to allow a user to intuitively recognize abnormal and harmful traffic that lowers the performance of a network and to easily determine security conditions in real time. The disclosed invention groups the collected security events on the basis of common characteristic information, divides the IP address of the event group, and displays the divided portions in a parallel coordinate system and/or a circular coordinate system.

### TECHNICAL FIELD

The present invention relates to an apparatus and method of dividing and displaying an IP address, and more particularly, to an apparatus and method of dividing and displaying an IP address capable of analyzing the type of network attack and the details of the attack. This work was supported by the IT R&D program of MIC/IITA [2007-S-022-01, The Development of Smart Monitoring and Tracing System against Cyber-attack in All-IP Network].

### BACKGROUND ART

In recent years, with an increase in the use of networks, illegal access to the network has increased. Therefore, a network security technique for detecting a network error, such as illegal attack, and preventing the attack has become important.

In the related art, in order to detect a network error (that is, abnormal conditions of the network caused by the attack), the ratio of any one of the traffic information items of the network, such as a network (or system) address, a protocol, a port number, and the number of packets, is used to analyze the state of the corresponding item. As another method, data transmitted through the network is represented in a coordinate plane or a geometrical figure to display abnormal conditions in the form of the entire network.

However, these methods according to the related art are difficult to accurately classify and represent network conditions corresponding to a specific error or a specific attack, which makes it difficult to detect a network error due to a new attack. In addition, when a plurality of attacks, no a single attack, is made, a small number of attacks are not considered in many cases.

Further, a network state image or a graph represents only whether abnormal traffic occurs. That is, since the type of attack is not accurately represented, it is difficult to provide countermeasures for abnormal conditions. As a result, it takes a lot of time for the administrator to find harmful traffic causing the abnormal conditions and to provide countermeasures for the abnormal conditions.

### DISCLOSURE

### Technical Problem

The invention is designed to solve the above problems, and an object of the invention is to provide an apparatus and method of dividing and displaying an IP address that displays a combination of important attributes of security events to allow a user to intuitively recognize abnormal and harmful traffic that lowers the performance of a network and to easily determine security conditions in real time.

### Technical Solution

In order to achieve the object, an embodiment of the invention provides an apparatus for dividing and displaying an IP address. The apparatus includes: an event characteristic grouping unit that combines characteristic information items of collected security events to generate an event group; and division display unit that divides an IP address of the event group on the basis of an Internet address scheme, and displays the divided portions in a coordinate system.

The event characteristic grouping unit may include: a security event collecting unit that collects the security events; and an event grouping unit that aligns traffic for each protocol on the basis of the characteristic information items of the security events received from the security event collecting unit, and combines the characteristic information items of the security events for each protocol to generate the event group.

The event grouping unit may select one or two elements from the characteristic information items of the security events for each protocol and combine the selected elements.

The characteristic information items of the security events for each protocol may include a source IP address, a destination IP address, a destination port, and a source port.

The division display unit may display the IP address of the event group in a parallel coordinate system having two or more parallel axes. In this case, the division display unit may divide the IP address of the event group into two or more sub-network values, and display the divided two or more sub-network values in the shapes of points on the corresponding parallel axes.

The division display unit may display the IP address of the event group in a circular coordinate system having two or more circular axes. In this case, the division display unit may divide the IP address of the event group into two or more sub-network values, and display the divided two or more sub-network values in the shapes of points on the corresponding circular axes.

The division display unit may display the IP address of the event group in a parallel coordinate system having two or more parallel axes and in a circular coordinate system having two or more circular axes. In this case, the division display unit may divide the IP address of the event group into two or more sub-network values, and display the divided two or more sub-network values in the shapes of points on the corresponding circular axes and parallel axes.

The division display unit may connect the displayed points.

The division display unit may display the distribution of an IP address that does not participate in the combination in the event group in a coordinate system, the distribution of the IP address of the event group exceeding a threshold value.

Another embodiment of the invention provides a method of dividing and displaying an IP address. The method includes: n event group generating step of allowing an event characteristic collecting unit to combine characteristic information items of collected security events to generate an event group; and a division display step of allowing a division display unit to divide an IP address of the event group generated in the event group generating step, on the basis of an Internet address scheme, and to display the divided portions in a coordinate system. The event group generating step may include: a first step of collecting the security events; and a second step of aligning traffic for each protocol on the basis of the characteristic information items of the collected security events, and combining the characteristic information items of the security events for each protocol to generate the event group.

The second step may select one or two elements from the characteristic information items of the security events for each protocol and combines the selected elements.

The characteristic information items of the security events for each protocol may include a source IP address, a destination IP address, a destination port, and a source port.

The division display step may display the IP address of the event group in a parallel coordinate system having two or more parallel axes. In this case, the division display step may divide the IP address of the event group into two or more sub-network values, and display the divided two or more sub-network values in the shapes of points on the corresponding parallel axes.

The division display step may display the IP address of the event group in a circular coordinate system having two or more circular axes. In this case, the division display step may divide the IP address of the event group into two or more sub-network values, and display the divided two or more sub-network values in the shapes of points on the corresponding circular axes.

The division display step may display the IP address of the event group in a parallel coordinate system having two or more parallel axes and in a circular coordinate system having two or more circular axes. In this case, the division display step may divide the IP address of the event group into two or more sub-network values, and display the divided two or more sub-network values in the shapes of points on the corresponding circular axes and parallel axes.

The division display step may connect the displayed points.

The division display step may display the distribution of an IP address that does not participate in the combination in the event group in a coordinate system, the distribution of the IP address of the event group exceeding a threshold value.

### ADVANTAGEOUS EFFECTS

According to the above-described embodiments of the invention, it is possible to easily determine and detect abnormal traffic or attacks that lower the performance of a network by displaying the distribution of source and destination IP addresses of an event group in a parallel coordinate system and/or a circular coordinate system, according to the result of a combination of main attributes of security events (particularly, events related to traffic).

It is possible to rapidly provide countermeasures for abnormal conditions without the interruption of an administrator, by automating these processes with a program.

Further, it is possible to allow the administrator to rapidly recognize a network error and to provide countermeasures for the network error by providing a parallel coordinate chart and a circular coordinate chart of IP addresses that are capable of providing easy viewing of abnormal conditions, and abnormal traffic information or harmful traffic causing the abnormal conditions. It is possible to easily detect the current traffic address and destination host conditions. In particularly, it is possible to easily monitor, for example, the access states of the main servers, which provide services, to the host, a scanning attack, and an Internet-worm attack.

### DESCRIPTION OF DRAWINGS

FIG. 1 is a block diagram illustrating the structure of an apparatus for dividing and displaying an IP address according to an embodiment of the invention.

FIG. 2 is a diagram illustrating an example of a parallel coordinate chart displayed by a parallel coordinate division display unit shown in FIG. 1.

FIG. 3 is a diagram illustrating an example of a circular coordinate chart displayed by a circular coordinate division display unit shown in FIG. 1.

FIGS. 4 and 5 are photographs of a parallel coordinate chart and a circular coordinate chart illustrating an Internet-worm attack displayed by a division display unit shown in FIG. 1.

FIGS. 6 and 7 are photographs of a parallel coordinate chart and a circular coordinate chart illustrating a host scanning attack displayed by the division display unit shown in FIG. 1.

FIG. 8 is a flowchart illustrating a method of dividing and displaying an IP address according to another embodiment of the invention.

### BEST MODE

Hereinafter, an apparatus and method of dividing and displaying an IP address according to an exemplary embodiment of the invention will be described with reference to the accompanying drawings.

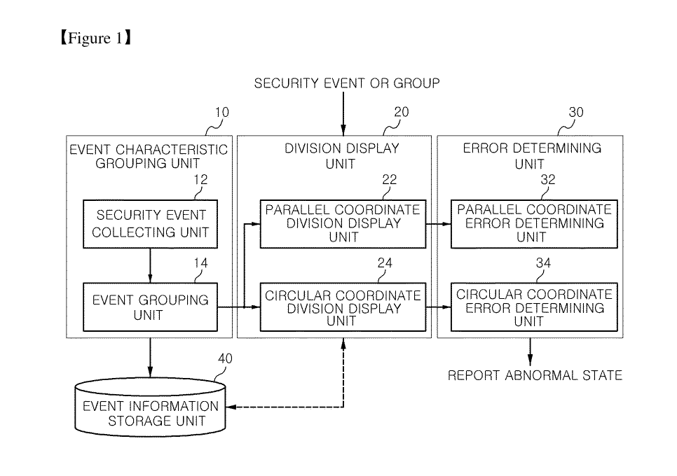

FIG. 1 is a block diagram illustrating an apparatus for dividing and displaying an IP address according to an exemplary embodiment of the invention. The apparatus for dividing and displaying an IP address shown in FIG. 1 includes an event characteristic grouping unit 10, a division display unit 20, an error determining unit 30, and an event information storage unit 40. The event characteristic grouping unit 10 classifies collected security events according to protocols, and groups the security events classified according to protocols on the basis of characteristic information. In this embodiment, characteristic information means a small number of characteristics, which are necessary and sufficient conditions required to check network errors, among various characteristics included in network packets transmitted from a source to a destination. In general, the network packet has various attributes including, for example, a source IP address, a destination IP address, a protocol, a destination port, and a source port. For example, in the following description, the above-mentioned attributes (that is, the source IP address, the destination IP address, the protocol, the destination port, and the source port) are defined as characteristic information.

The event characteristic grouping unit 10 includes a security event collecting unit 12 and an event grouping unit 14.

The security event collecting unit 12 collects security events transmitted from network security apparatuses (not shown), such as a fire wall, an intrusion detection system, and a router.

The event grouping unit 14 aligns traffic for each protocol on the basis of the characteristic information of the security events collected by the security event collecting unit 12, and generates event groups on the basis of the characteristic information of the security events for each protocol. The event grouping unit 14 stores the event groups in the event information storage unit 40. In FIG. 1, the event characteristic grouping unit 10 is separately configured from the event information storage unit 40, but the event information storage unit 40 may be included in the event grouping unit 14.

In order to generate the event groups, the event grouping unit 14 selects one or two elements from the characteristic information of the security events for each protocol, that is, the source IP address, the destination IP address, the destination port, and the source port, and combines the selected elements. As the result of the combination, the event grouping unit 14 extracts a group of events “(source IP address), (destination IP address), (destination port), (source port), (source IP address, destination IP address), (source IP address, destination port), (source IP address, source port), (destination IP address, destination port), (destination IP address, source port), and (destination port, source port)”. Of course, the event grouping unit may select three elements and combine the selected elements.

For example, assuming that the source IP address is combined with the source port, the security events in which the source IP address is identical with the source port are grouped. An event group (that is, a group of events) generated by combining the same elements includes events having a plurality of destination ports and a plurality of destination IP addresses, which do not participate in the combination. That is, when two elements are combined, the distribution of the other two elements that do not participate in the combination occurs in the event group. The event information storage unit 40 stores information of the event group as well as the security events for each protocol.

The division display unit 20 divides the source IP address or the destination IP address that does not participate in the combination in each of the event groups received from the event grouping unit 14, on the basis of an IP address scheme, and displays the divided portions in a parallel coordinate system and a circular coordinate system. In the division display of the IP address in the coordinate systems, it is preferable that the division display unit 20 divide the IP address of the event group that exceeds a specific threshold value (set value) and display the divided portion in the parallel coordinate system and the circular coordinate system. The division display unit 20 counts the number of event groups provided from the event grouping unit 14. The specific threshold value means a predetermined count number. For example, when an event to be analyzed uses netflow for 5 minutes in a 155M network environment, the specific threshold value may be set to “50”. The specific threshold value (set value) depends on a user and a network environment. This is to easily determine whether errors and abnormal traffic occur by displaying only the distribution of the source and destination IP addresses of the event group that exceeds the threshold value, when the main attributes of the events related to traffic generated for each protocol are combined.

The division display unit 20 includes a parallel coordinate division display unit 22 and a circular coordinate division display unit 24.

The parallel coordinate division display unit 22 receives an event group (that is, a group of events) from the event grouping unit 14. The parallel coordinate division display unit 22 divides the source IP address or the destination IP address that does not participate in the combination in each of the received event groups, on the basis of an IP address scheme, and displays the divided portions in the parallel coordinate system.

The circular coordinate division display unit 24 receives an event group (that is, a group of events) from the event grouping unit 14. The circular coordinate division display unit 24 divides the source IP address or the destination IP address that does not participate in the combination in each of the received event groups, on the basis of an IP address scheme, and displays the divided portions in the circular coordinate system.

The division display unit 20 may receive security events and event groups from an external apparatus other than the event grouping unit 14.

When receiving a signal indicating that events have been completely grouped, not information on the event group, from the event grouping unit 14, the parallel coordinate division display unit 22 and the circular coordinate division display unit 24 may divide the IP address and display the divided portions in the parallel coordinate system and the circular coordinate system, on the basis of information stored in the event information storage unit 40.

The error determining unit 30 determines whether a network error occurs on the basis of information displayed by the division display unit 20. In addition, the error determining unit 30 detects abnormal traffic or harmful traffic causing the network error and reports the result of the detection. The error determining unit 30 includes a parallel coordinate error determining unit 32 and a circular coordinate error determining unit 34.

The parallel coordinate error determining unit 32 detects a network error on the parallel coordinates displayed by the parallel coordinate division display unit 22, and classifies the detected network error. The parallel coordinate error determining unit 32 detects abnormal traffic or harmful traffic causing the classified network error, and reports the result of the detection to an administrator or an operator.

The circular coordinate error determining unit 34 detects a network error on the circular coordinates displayed by the circular coordinate division display unit 24, and classifies the detected network error. The circular coordinate error determining unit 34 detects abnormal traffic or harmful traffic causing the classified network error, and reports the result of the detection to the administrator or the operator.

The parallel coordinate error determining unit 32 and the circular coordinate error determining unit 34 may report the result of the detection in various forms, such as the output of a print-out from a printer, the generation of an alarm sound from a buzzer, the output of a voice message from a speaker, and the display of characters and figures on a monitor.

Those skilled in the art can easily understand the operation of the error determining unit 30 determining the network error and the type of errors and detecting harmful traffic or abnormal traffic on the basis of information displayed by the division display unit 20.

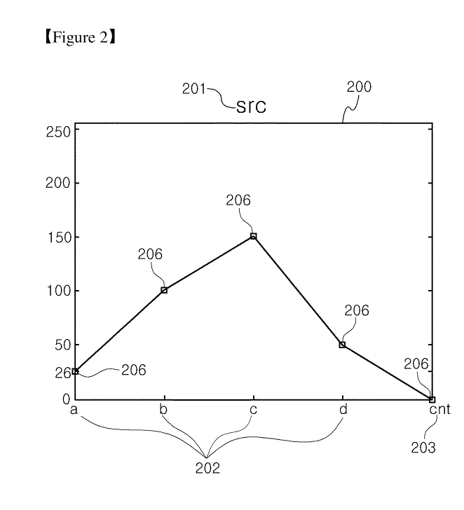

FIG. 2 shows an example of a parallel coordinate chart displayed by the parallel coordinate division display unit 22 shown in FIG. 1.

In a parallel coordinate chart 200, reference numeral 201 denotes a title indicating the attribute of an IP address (for example, a source IP address or a destination IP address). Reference numeral 202 denotes an IP address represented by an Internet address scheme. The IP address 202 generally has a length of 32 bits, and includes four attribute fields “a.b.c.d” (each of which is composed of 8 bits). The IP address 202 is divided into four 8-bit sub-network values. The divided sub-network values (one sub-network value is composed of one attribute field) are represented on each parallel axis on the X-axis in the forms of identifiers (that is, a, b, c, and d). Reference numeral 203 denotes the number of events (cnt) that increases whenever the event composed of “a.b.c.d” is generated. The event number 203 is represented as the last parallel axis on the X-axis.

Numerical values “0”, “26”, “50”, “100”, “150”, “200”, and “250” represented on the Y-axis is to improve the identification of the range of the IP address 202. The value of “a” (“26”), which is the first attribute field of the IP address 202, is represented on the Y-axis to improve the identification performance. The values of “b”, “c”, and “d” (“100”, “150”, and “50”), which are the other attribute fields of the IP address 202, are represented in the forms of points 206 at the points where the parallel axes intersect the Y-axis. The points 206 may be represented in the shapes of triangles or rectangles. Of course, the event number 203 is also represented in the shape of a point.

In order to improve the identification performance, the parallel coordinate division display unit 22 links the points 206 and the event number 203 on the parallel coordinate chart 200 to draw a line graph.

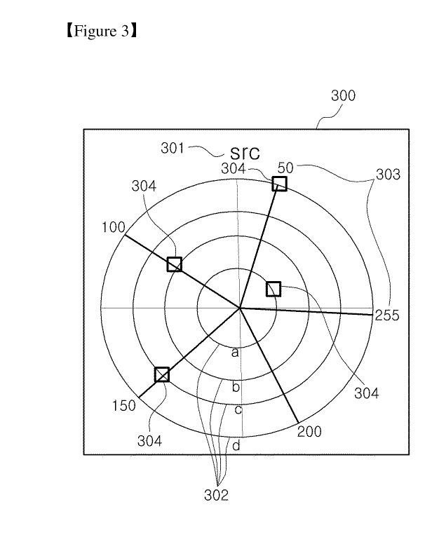

FIG. 3 shows an example of a circular coordinate chart displayed by the circular coordinate division display unit 24 shown in FIG. 1.

In a circular coordinate chart 300, reference numeral 301 denotes a title indicating the attribute of an IP address (for example, a source IP address or a destination IP address). Reference numeral 302 denotes a circular axis that divides the attribute field of the IP address. That is, the IP address generally has a length of 32 bits, and includes four attribute fields “a.b.c.d” (each of which is composed of 8 bits). The IP address is divided into four 8-bit sub-network values. The divided sub-network values are represented on the corresponding circular axes. The circular axes include four circular axes. In FIG. 3, the innermost circular axis is for the attribute field “a”, followed by the circular axes for the attribute fields “b”, “c”, and “d”. The values of attribute fields to be divided are represented in the shapes of points 304 on the corresponding circular axes 302. The points 304 may be represented in the shapes of triangles or rectangles. In order to facilitate the identification of the values of the points 304, identifiers 303 (“50”, “100”, “150”, “200”, and “250”) are represented on the outermost circular axis 302.

In this embodiment, the parallel coordinate division display unit 22 and the circular coordinate division display unit 24 divide the IP address and display the divided portions, but the IP address may be replaced with a port range. For example, the parallel axes and the circular axes may be changed to the port range defined by IANA (Internet assigned number authority), that is, a well known port range of 0 to 1023, a registered port range of 1024 to 49151), a dynamic and/or private port range of 49152 to 65535.

FIGS. 2 and 3 are the coordinate charts illustrating traffic conditions generated for one source IP address or one destination IP address. If necessary, traffic conditions for two or more source IP addresses or destination IP addresses may be represented on one parallel coordinate chart or one circular coordinate chart. In this case, the points displayed by the parallel coordinate division display unit 22 and the circular coordinate division display unit 24 may be represented in different shapes and colors according to the protocol in order to improve the identification thereof. When the IP address is replaced with the port range, port numbers may be displayed in different colors.

Further, in this embodiment of the invention, since it is assumed that the address scheme of the IP address is “a.b.c.d”, four parallel axes and four circular axes are used. If the address scheme of the IP address is changed, the number of parallel axes and circular axes are changed in correspondence with the change in the address scheme.

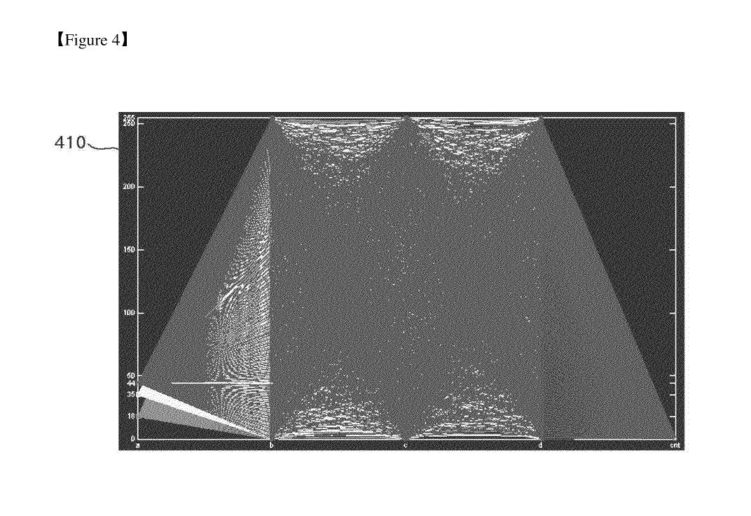

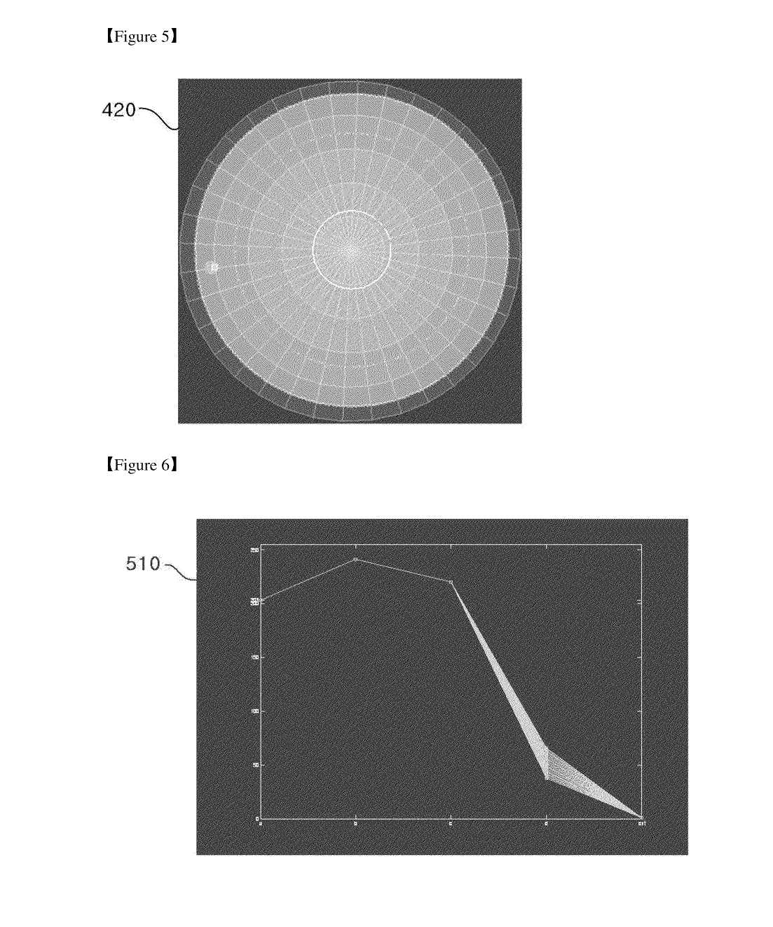

FIG. 4 is a photograph of a parallel coordinate chart illustrating an Internet-worm attack represented by the parallel coordinate division display unit 22 shown in FIG. 1, and FIG. 5 is a photograph of the circular coordinate chart illustrating an Internet-worm attack represented by the circular coordinate division display unit 24 shown in FIG. 1.

As can be seen from a photograph 410 of a parallel coordinate chart and a photograph 420 of the circular coordinate chart, the Internet-worm attack is uniformly distributed over the entire range of the IP address. For example, assuming that the IP address is represented by the address scheme “a.b.c.d”, the values of “b, c, and d” are distributed in a range of 0 to 255.

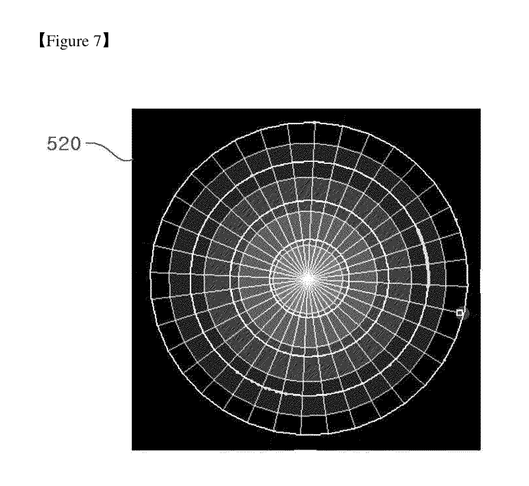

The error determining unit 30 can determine that the Internet-worm attack is being made, on the basis of this structure, and detect abnormal traffic or harmful traffic causing a network error. FIG. 6 is a photograph of a parallel coordinate chart illustrating a host scanning attack represented by the parallel coordinate division display unit 22 shown in FIG. 1, and FIG. 7 is a photograph of a circular coordinate chart illustrating a host scanning attack represented by the circular coordinate division display unit 24 shown in FIG. 1.

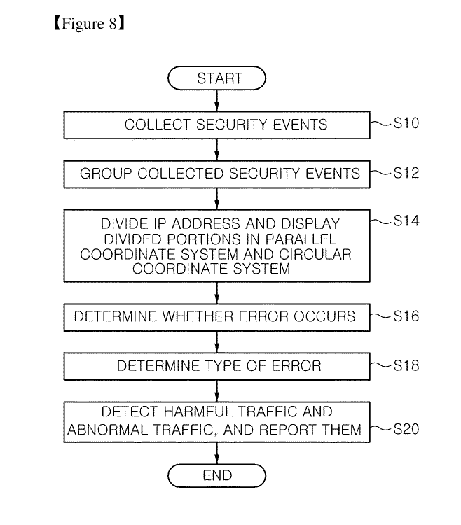

As can be seen from a photograph 510 of the parallel coordinate chart and a photograph 520 of the circular coordinate chart, the host scanning attack is continuously distributed in a predetermined range of the IP address. For example, assuming that the IP address is represented by the address scheme “a.b.c.d”, the value of “d” is distributed in a range of 37 to 75. The error determining unit 30 can determine that the host scanning attack is being made, on the basis of this structure, and detect abnormal traffic or harmful traffic causing a network error. FIG. 8 is a flowchart illustrating a method of dividing and displaying an IP address according to another embodiment of the invention.

First, the security event collecting unit 12 collects security events transmitted from a network security apparatus (not shown), such as a fire wall, an intrusion detection system, or a router (S10). The collected security events are transmitted to the event grouping unit 14.

The event grouping unit 14 aligns traffics for each protocol, on the basis of characteristic information of the received security events, selects one or two elements from the characteristic information of the security events for each protocol, and combines the selected elements. A group of events is extracted by the combination of the elements by the event grouping unit 14 (S12). For example, assuming that the source IP address and the source port are combined, the security events having the same source IP address and source port are grouped. As a result, an event group (that is, a group of events) generated by the event grouping unit 14 has events including a plurality of destination ports and a plurality of destination IP addresses that do not participate in the combination. That is, when two elements are combined, the distribution of the other elements that do not participate in the combination occurs in the event group.

Then, the parallel coordinate division display unit 22 of the division display unit 20 divides the source IP address or the destination IP address that does not participate in the combination in each of the event groups received from the event grouping unit 14, on the basis of an IP address scheme, and displays the divided portions in the parallel coordinate system shown in FIGS. 2, 4, and 6. The circular coordinate division display unit 24 of the division display unit 20 divides the source IP address or the destination IP address that does not participate in the combination in each of the event groups received from the event grouping unit 14, on the basis of an IP address scheme, and displays the divided portions in the circular coordinate system shown in FIGS. 3, 5, and 7 (S14).

The error determining unit 30 determines whether a network error occurs (S16), and determines the type of error (S18), on the basis of the content displayed by the division display unit 20. Then, the error determining unit 30 detects the type of abnormal traffic or harmful traffic causing the determined error, and reports the result of the detection (S20).

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An apparatus for dividing and displaying an IP address, comprising:
an event characteristic grouping unit that combines characteristic information items of collected security events to generate an event group; and
a division display unit that divides an IP address of the event group on the basis of an Internet address scheme, and displays the divided portions in a coordinate system.

2. The apparatus of claim 1,
wherein the event characteristic grouping unit includes:
a security event collecting unit that collects the security events; and
an event grouping unit that aligns traffic for each protocol on the basis of the characteristic information items of the security events received from the security event collecting unit, and combines the characteristic information items of the security events for each protocol to generate the event group.

3. The apparatus of claim 2,
wherein the event grouping unit selects one or two elements from the characteristic information items of the security events for each protocol and combines the selected elements.

4. The apparatus of claim 1,
wherein the division display unit displays the IP address of the event group in a parallel coordinate system having two or more parallel axes.

5. The apparatus of claim 4,
wherein the division display unit divides the IP address of the event group into two or more sub-network values, and displays the divided two or more sub-network values in the shapes of points on the corresponding parallel axes.

6. The apparatus of claim 1,
wherein the division display unit displays the IP address of the event group in a circular coordinate system having two or more circular axes.

7. The apparatus of claim 6,
wherein the division display unit divides the IP address of the event group into two or more sub-network values, and displays the divided two or more sub-network values in the shapes of points on the corresponding circular axes.

8. The apparatus of claim 1,
wherein the division display unit displays the IP address of the event group in a parallel coordinate system having two or more parallel axes and in a circular coordinate system having two or more circular axes.

9. The apparatus of claim 8,
wherein the division display unit divides the IP address of the event group into two or more sub-network values, and displays the divided two or more sub-network values in the shapes of points on the corresponding circular axes and parallel axes.

10. The apparatus of claim 1,
wherein the division display unit displays the distribution of an IP address that does not participate in the combination in the event group in a coordinate system, the distribution of the IP address of the event group exceeding a threshold value.

11. A method of dividing and displaying an IP address, the method comprising:
an event group generating operation of allowing an event characteristic collecting unit to combine characteristic information items of collected security events to generate an event group; and
a division display operation of allowing a division display unit to divide an IP address of the event group generated in the event group generating operation, on the basis of an Internet address scheme, and to display the divided portions in a coordinate system.

12. The method of claim 11,
wherein the event group generating operation includes:
a first operation of collecting the security events; and
a second operation of aligning traffic for each protocol on the basis of the characteristic information items of the collected security events, and combining the characteristic information items of the security events for each protocol to generate the event group.

13. The method of claim 12,
wherein the second operation selects one or two elements from the characteristic information items of the security events for each protocol and combines the selected elements.

14. The method of claim 11,
wherein the division display operation displays the IP address of the event group in a parallel coordinate system having two or more parallel axes.

15. The method of claim 14,
wherein the division display operation divides the IP address of the event group into two or more sub-network values, and displays the divided two or more sub-network values in the shapes of points on the corresponding parallel axes.

16. The method of claim 11,
wherein the division display operation displays the IP address of the event group in a circular coordinate system having two or more circular axes.

17. The method of claim 16,
wherein the division display operation divides the IP address of the event group into two or more sub-network values, and displays the divided two or more sub-network values in the shapes of points on the corresponding circular axes.

18. The method of claim 11,
wherein the division display operation displays the IP address of the event group in a parallel coordinate system having two or more parallel axes and in a circular coordinate system having two or more circular axes.

19. The method of claim 18,
wherein the division display operation divides the IP address of the event group into two or more sub-network values, and displays the divided two or more sub-network values in the shapes of points on the corresponding circular axes and parallel axes.

20. The method of claim 11,
wherein the division display operation displays the distribution of an IP address that does not participate in the combination in the event group in a coordinate system, the distribution of the IP address of the event group exceeding a threshold value.
